(19) United States
(12) Patent Application Publication
(10) Pub. No.: US 2009/0106744 A1
(43) Pub. Date: Apr. 23, 2009

(54) Compiling and translating method and apparatus

(76) Inventors: Jianhui Li, Shanghai (CN); Yun Wang, Shanghai (CN); Bo Huang, Shanghai (CN); Yongnian Le, Shanghai (CN); Jiangning Liu, Shanghai (CN); Jinyun Ye, Shanghai (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/576,907

(22) PCT Filed: Aug. 5, 2005
(86) PCT No.: PCT/CN05/01204

§ 371 Date: Apr. 21, 2006

(51) Int. Cl. G06F 9/45

(52) U.S. Cl. 717/151

(57) ABSTRACT

Methods and apparatus are described to compile and translate source code. In some embodiments, source code is compiled into source binary code for a source platform; an annotation section associated with the source binary code is generated, wherein the annotation section comprises an annotation for a scope, the scope comprising at least one block of the source binary code having at least one attribute to aid a translator optimization. If the scope comprises a plurality of blocks, the blocks have consecutive addresses with each other and have the at least one attribute in common. In the embodiments, the source binary code is further translated into target binary code for a target platform by utilizing the annotation section.

This U.S. Patent application claims priority to PCT/CN2005/001204 filed in China on Aug. 5, 2005.

### BACKGROUND

A compiler is used to compile source code written in a programming language such as C, Pascal, Fortran, etc. to binary code for a target platform. Certain attributes of the source code, such as procedure boundary, variable live ranges and memory object bounds, are not included in the resultant binary code. For example, a translator may translate binary code for a source instruction architecture to binary code for a target instruction architecture.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a system comprising a source computing device and a target computing device;

FIG. 2 illustrates an embodiment of a compiler in the source computing device of FIG. 1;

FIG. 3 illustrates an embodiment of a translator in the target computing device of FIG. 1;

FIG. 4 illustrates an embodiment of a compiling method used by the compiler of FIG. 2;

FIG. 5 illustrates an embodiment of a translating method used by the translator of FIG. 3; and

FIG. 6 illustrates an embodiment of an annotation table.

### DETAILED DESCRIPTION OF THE PREFERRED EMBODIMENTS

The following description describes techniques for generating binary code having annotations that aid translating the binary code for a computing platform to binary code for another computing platform. In the following description, numerous specific details such as logic implementations, pseudo-code, means to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

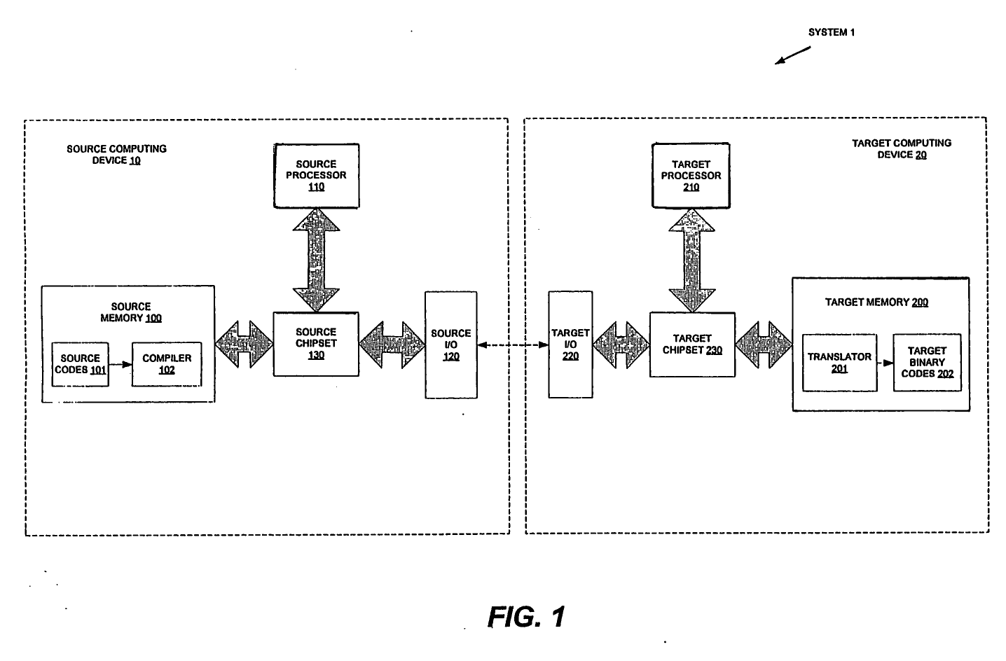

An embodiment of source code compiling and translating system is shown in FIG. 1. As shown, the system 1 may comprise a source computing device 10 complying with a source platform specification. The system 1 may further comprise a target computing device 20 complying with a target platform specification. A non-exhaustive list of examples for the source computing device 10 and the target computing device 20 may comprise a personal computer, a workstation, a server computer, a personal digital assistant (PDA), a mobile telephone, a game console and the like.

In an embodiment, the source computing device 10 may compile source code programmed in a programming language such as C, Pascal, Fortran, etc. into source binary code for the source platform, and the target computing device 10 may translate the source binary code into target binary code that may be executed under the target platform. In other embodiments, the source binary code may be generated for another target platform.

The source computing device 10 may further collect information during compiling the source code and generate an annotation section based on the collected information that may be used by the target computing device 20 to translate the source binary code. The annotation section may comprise an annotation for a scope, wherein the scope may comprise at least one block having at least one attribute to aid the target computing device 20 in translating the source binary code.

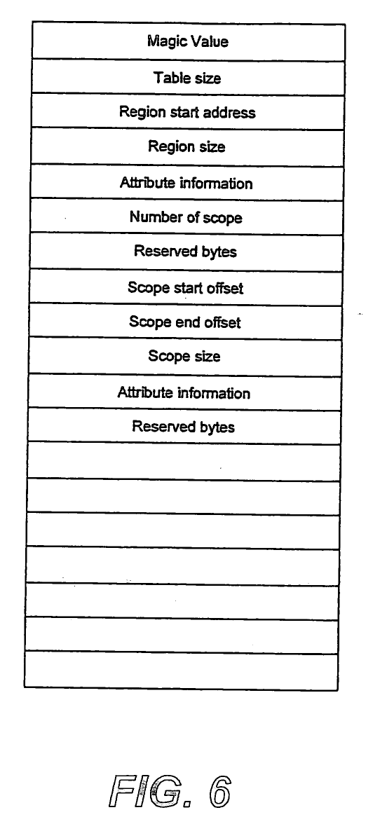

In one embodiment, the source computing device 10 may comprise: a source memory device 100, a source processor 110, a source I/O device 120 and a source chipset 130. The source memory device 100 may store the source code 101 and a compiler 102 to compile the source code into the source binary code and may generate an annotation section based upon a predetermined annotation format. An example of the annotation format is shown in FIG. 6. A non-exhaustive list of examples for the source memory device 100 may include one or any combination of the following semiconductor devices, such as synchronous dynamic random access memory (SDRAM) devices, RAMBUS dynamic random access memory (RDRAM) devices, double data rate (DDR) memory devices, static random access memory (SRAM), flash memory devices, and the like.

The source processor 110 may execute instructions stored in the source memory device 100 and may control the operation of the source computing device 10. In one embodiment, the source processor 110 may execute instructions defined by the Intel® Architecture-32 (IA-32) instruction set. In an embodiment, the source processor 110 may execute the compiler 102 to compile the source code 101 into the source binary code and may generate the annotation section in the pre-determined format. The processor 110 may further control the I/O device 120 to output the source binary code and the annotation section. A non-exhaustive list of examples for processor 110 may include a central processing unit (CPU), a digital signal processor (DSP), a reduced instruction set computer (RISC), a complex instruction set computer (CISC) and the like.

The source I/O device 120 may output the source binary code and the annotation section through various ways, for example, a recordable medium, such as a floppy disc, a compact disc, etc., or a network, such as Internet, LAN, etc. In an embodiment, the source I/O device 120 may comprises a keyboard, mouse, floppy disc drive, an IDE (integrated drive electronics) drive, an USB drive, and the like. The source I/O drive 130 may further comprise a network card that is connected with the Internet, LAN, WLAN, and the like.

The source chipset 130 may provide an interface for the source memory device 100, the source processor 110 and the source I/O device 120 and may control the data communication among them. The source chipset 130 may comprise a processor bus interface to connect with the source processor 110, and one or more integrated circuit devices, such as a memory controller hub, a I/O controller hub, and so on.

The target source 20 may comprise a target memory device 200, a target processor 210, a target I/O device 220, and a target chipset 230. The target memory device 200 may store a translator 201 to translate the source binary code into the target binary code 202 that is executable by the processor 210. In an embodiment, the translator 201 may determine whether an optimization is needed and perform the optimization by use of the annotation section output from the source computing device 10. The translator 201 may refer to the annotation format, for example, the format as shown in FIG. 6, when using the annotation section for optimization. A non-exhaustive list of examples for the target memory device 200 may include one or any combination of the following semiconductor devices, such as synchronous dynamic random access memory (SDRAM) devices, RAMBUS dynamic random access memory (RDRAM) devices, double data rate (DDR) memory devices, static random access memory (SRAM), flash memory devices, and the like.

The target processor 210 may execute the instructions in the target memory device 200 and may control the operation of the target computing device 20. In one embodiment, the target processor 210 may execute instructions specified by Itanium® Processor Family instruction set. In an embodiment, the target processor 210 may control the input of the source binary code and annotation section by the target I/O device 220. The target processor 210 may further execute the translator 201 to translate the source binary code to the target binary code by utilizing the annotation section. A non-exhaustive list of examples for processor 110 may include a central processing unit (CPU), a digital signal processor (DSP), a reduced instruction set computer (RISC), a complex instruction set computer (CISC) and the like.

The target I/O device 120 may input the source binary code and the annotation section through various ways, for example, a recordable medium, such as a floppy disc, a compact disc, etc., or a network, such as Internet, LAN, etc. In an embodiment, the target I/O device 220 may comprises a keyboard, mouse, floppy disc drive, an IDE (integrated drive electronics) drive, an USB drive, and the like. The target I/O drive 220 may further comprise a network card that is connected with the Internet, LAN, WLAN, and the like.

The target chipset 230 may provide an interface for the target memory device 200, target processor 210 and the target I/O device 220 and control the data communication among them. The target chipset 230 may comprise a processor bus interface to connect with the target processor 210, and one or more integrated circuit devices, such as a memory controller hub, an I/O controller hub, and so on.

Other embodiments may implement other modifications and variations to the structure of system 1 in FIG. 1. For example, the source computing device 10 and/or target computing device 20 may comprise two or more processors, each of that may perform under any suitable architecture. For another example, the source computing device 10 and the target computing device 20 may be integrated into one computing device, and the translator 201 may obtain the source binary code from the compiler 102 via memory or another storage medium of the computing device.

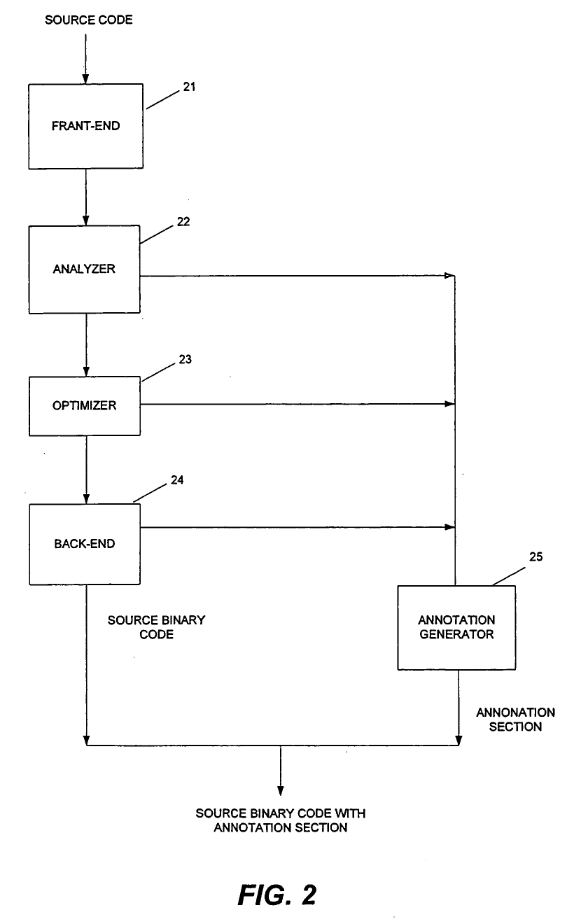

An embodiment of the compiler 102 is shown in FIG. 2. The compiler 102 may comprise a front-end 21, an analyzer 22, an optimizer 23, a back-end 24 and an annotation generator 25.

The front-end 21 may convert the source code 101 in FIG. 1 into source intermediate code in an internal data structure that is easier for other parts of the compiler (e.g., the analyzer, optimizer and the back-end of the compiler) to process. The front-end 21 may be responsible for identifying each lexical group of the source code 101 (e.g., characters including words, signs, spaces, etc.); canceling any useless spaces, carriage returns, or any insignificant characters; performing lexical check and reporting errors; and outputting the result code in a pre-determined internal data structure.

The analyzer 22 may perform a control flow and a data flow analysis to the source intermediate code and then divide the source intermediate code into blocks. In an embodiment, the analyzer 22 may comprise a control flow analyzer to produce a control-flow graph that is easier for the compiler 102 to manipulate; and a data flow analyzer to examine how data is used in the source code.

The analyzer 22 may further collect information associated with one or more blocks and provide the same with the annotation generator 26. In an embodiment, the collected information may comprise a block list to list every attribute of a block. One example for the attribute may be a memory dependent attribute, namely, whether two or more variables in a block refer to the same memory. The memory dependent attribute may be useful for the translator to know whether two memory access can be interchanged or not.

In an embodiment, the optimizer 23 may optimize the source intermediate code after the analyzer 22. In other embodiments, the optimization may be performed after other stages, such as lexical parsing stage, control flow/data flow analysis stage, or even after converting stage that will be discussed later with reference to the back-end 24. The optimization may focus on saving space needed for storing the code, the time consumed for running the code and other aspects.

The optimizer 24 may further provide the annotation generator 26 with another block list collecting attributes for blocks. Moreover, the optimizer 24 may further update the block list(s) sent in other stages, such as analysis stage, or even in converting stage. For example, if a loop A is iterated by 100 times, then the analyzer 22 may send a block list indicating loop account attribute (i.e., loop account=100) for related blocks (e.g., block 4, block 5 and block 6) to the annotation generator 26. In the optimization stage, the loop might be unrolled by 4 times. That is to say, the loop body is repeated by 4 times and thus the loop counter is reduced to 25. In this case, the optimizer 24 may update the block list in the annotation generator 26 that indicates loop account attribute for the block 4, 5 and 6 is 25.

The back-end 24 may convert the source intermediate code to the source binary code. The back-end 25 may further select instructions, allocate register and reorder the instructions for the source binary code. The back-end 24 may comprise a converter and a register allocating, instruction selecting and reordering unit to perform the above-described functionalities. The back-end 24 may further provide the annotation generator 25 with a block list to list attributes for blocks that are collected in the converting stage.

In an embodiment, the back-end 24 may send a spilling/restoring attribute for a block of the source binary code. In an embodiment, a bit map for a block is made while each bit represents spilling or restoring instruction (e.g., bit “1”) or other instructions (e.g., “0”) for each instruction of the block. Then, the bit map is encoded into the spilling/restoring attribute for the block. One exemplary encoding method is to record the number of ‘0’ and ‘1’ in the bit map for the block. Here, the spilling/restoring instruction may refer to an instruction of allocating a value from the register to the memory (spilling) or restoring the value from the memory to the register (restoring).

In another embodiment, the back-end 24 may send a volatile variable access attribute for a block to the annotation generator 26. The volatile variable access attribute may indicate whether the block contains a memory access to the volatile variable.

In still another example, the back-end 25 may send a block list indicating local variable address assignment attribute for blocks. The local variable address assignment attribute may refer to whether the address of a variable in a function comprising a plurality of blocks is assigned to another variable outside of the function.

The back-end 24 may further send other information than the annotation described above to the annotation generator 25, such as block start/end addresses.

The annotation generator 25 may generate an annotation section based on the block lists collected by the analyzer 22, optimizer 23 and the back-end 24. The annotation section may be in variable forms. In an embodiment, an annotation section may comprise at least one annotation table, while each annotation table may store annotation for a code region. If the annotation section comprises a plurality of annotation tables, addresses (e.g., begin/end addresses) used for one region may not be used for another region.

The code region may further comprise at least one scope, while each scope may comprise at least one block having an attribute to aid the target computing device 20 to translate the source code. However, if the scope comprises a plurality of blocks, the blocks may have consecutive addresses with each other and at least one attribute in common. Taking the spilling/restoring attribute as an example, consecutive blocks having at least one spilling/restoring instruction may be grouped as a scope and/or consecutive blocks having no spilling/restoring instruction may be grouped as another scope. Taking the local variable address assignment attribute as another example, the consecutive blocks having the attribute that the local variable address can be or can not be assigned to another variable may be grouped as another scope.

An example of a format for an annotation table is shown in FIG. 6. As shown, the annotation table may comprise a region level annotation and a scope level annotation. The region level annotation may comprise the region start/end addresses, region size, attribute information for each block of the region, number of scopes included in the region, etc. The scope level annotation may comprise scope start/end address (or offset), scope size, attribute information for each block of the scope, etc. The attribute information in the region level annotation and/or in the scope level annotation may comprise attribute number, attribute type, and attribute content, etc.

Other embodiments may implement other modifications and variations to the annotation table of FIG. 6. For example, if a region has only one scope, the region level annotation can be omitted. For another example, the annotation table may further comprise a magic value to store an annotation table pointer. For still another example, the order of the items in the annotation table may be interchangeable.

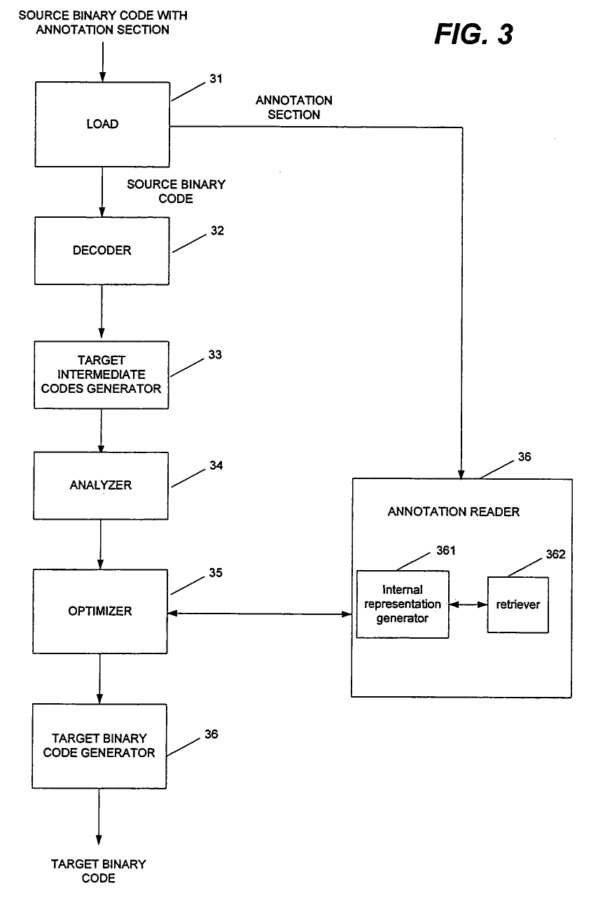

An embodiment of the translator 201 is shown in FIG. 3. As shown, the translator 201 may comprise a loader 31, a decoder 32, a target intermediate code generator 33, an analyzer 34, optimizer 35, an annotation reader 36 and target binary code generator 37. The loader 31 may separate the source binary code from the annotation section after inputting them from the source computing device 10. The decoder 32 may disassemble the source binary code read from the loader 31 and produce a binary stream that the target intermediate code generator 33 is designed to recognize and execute. The target intermediate code generator 33 may transform the binary stream into target intermediate code. In an embodiment, the target intermediate code generator 33 generates the target intermediate code by simulating the semantic of the source instructions with one or more target architecture instructions.

The analyzer 34 may perform control flow analysis and data flow analysis on the target intermediate code so as to construct a control flow and data flow graphs.

The optimizer 35 may perform the optimization with assistance from the annotation reader 36 in response to determining that the optimization is needed. In an embodiment, the optimizer 35 may make the determination according to whether a block is frequently used, and/or whether overhead for optimization of the block is reasonable. In another embodiment, the determination for optimization may be made based upon a profiling of the target binary code output from the target binary code generator 37. The optimization may be made in one or more specific translation stages, or in the whole process of the translation. In an embodiment, the optimization is performed after the analyzer. In other embodiments, the optimization may be performed after other components of the translator, such as the target intermediate code generator 33, or even after the target binary code generator 37. Alternatively, the optimizer 35 may be omitted in the translator, and the optimization may performed within other components of the translator, for example, the optimization may be performed in the target intermediate code generator 33, the analyzer 34, or even in the target binary code generator 37.

In an embodiment, the optimization may be performed for register restoring. If the target architecture has more registers than the source architecture and a block is selected for optimization, the optimizer 35 may instruct the annotation reader to read spilling/restoring attribute for the block. Based on the spilling/restoring attribute that indicates whether the block has instructions marked for spilling/restoring, the optimizer 35 may relax the memory ordering requirement for the memory accesses of these spilling/restoring instructions, and even replace the spilling/restoring instructions as register access instructions.

In another embodiment, optimization may be performed for local variable address assignment for a block. In the optimization stage, the optimizer will instruct the annotation reader 36 to read the local variable address assignment attribute for the block. If the information from the annotation reader 36 shows that the address of the local variable in a function including the block is not assigned to another variable outside of the function, the optimizer will disambiguate the memory accesses to these two variables, and relax the memory ordering requirement for the memory accesses to the variables.

In still another embodiment, optimization may be performed for volatile variable access for the analysis stage. In the optimization stage, the optimizer may instruct the annotation reader 36 to read the volatile variable access attribute for the block. If the information from the annotation reader 36 shows that the block accesses a volatile variable, the optimizer may relax the memory ordering requirement for all memory accesses inside the block.

In response to the instruction from the optimizer 35, the annotation reader 36 may retrieve an annotation for a targeted block. The instruction may comprise the memory address of the targeted block. As shown in FIG. 3, the annotation reader 36 may comprise an internal representation generator 361 and a retriever 362.

If it is the first time for the annotation reader 36 to retrieve an annotation from the annotation section input from the loader 31, the internal representation generator 361 may generate a primary internal representation for the annotation section. In an embodiment, the primary internal representation may be an AVL tree (The AVL tree is named after its inventors, G. M. Adelson-Velsky and E. M. Landis) with each node of the tree representing an annotation table for a region. For example, each node of the AVL tree may comprise the begin address of a region, region size, and pointer to the annotation table. In other embodiment, the primary internal representation may be a B+tree.

The internal representation generator 361 may further generate a secondary internal representation for each annotation table. In an embodiment, the secondary internal representation may be an AVL tree, with each node of the tree representing each scope of the region in the annotation table. For example, each node of the AVL tree may comprise scope begin address, scope size and attribute that the blocks of the scope may have.

The retriever 362 of the annotation reader 36 may retrieve the attribute for the targeted block from the internal representation generated by the internal representation generator 361.

Other embodiments may implement other modification and variations to the structure of the annotation reader 36. For example, the annotation internal generator 361 may be omitted and the retriever 362 may retrieve the attribute directly from the annotation tables of the annotation section. For another example, the secondary annotation internal representation may be omitted, and the retriever 362 may retrieve the annotation table for a region including the targeted block from the primary internal representation and then retrieve the attribute from the annotation table.

The target binary code generator 37 may convert the target intermediate code into target binary code 202. The target binary code generator 37 may comprise a target intermediate code translator (not shown in FIG. 3) to translate the target intermediate code to target-machine instructions; and a binary file encoder (not shown in FIG. 3) to write target binary code in the required format.

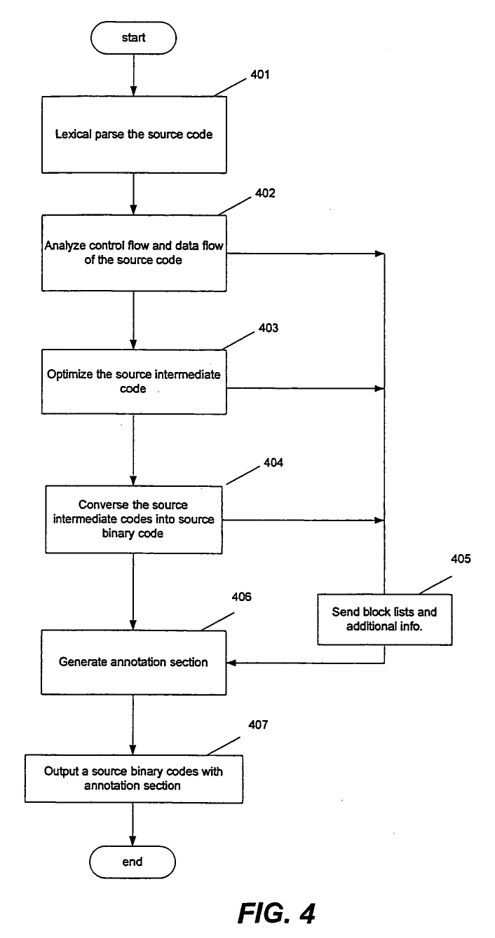

FIG. 4 shows an embodiment of a compiling method to compile the source code into the source binary code. In block 401, the front-end 21 of the compiler 102 may lexical parse the source code. In block 402, the analyzer 22 of the compiler 102 may perform control flow and data flow analysis to the source code. Then, the analyzer 22 may further send the annotation generator 25 with a block list containing attributes collected in the analysis stage and/or in the lexical parsing stage in block 405.

In block 403, the optimizer 23 of the compiler 102 may optimize the code output from the analyzer 22. As aforementioned, the optimization may be performed in various ways. In the embodiment shown in FIG. 4, the optimization may be performed after the analysis stage (block 402). In other embodiment, the optimization may be performed after the lexical parsing stage (block 401), or even after the converting stage that will be described with reference to block 404. Then, the optimizer 23 may further send the annotation generator 25 with a block list containing attributes for related blocks and/or update block lists provided by other components of the compiler 102.

In block 404, the back-end 24 of the compiler 102 may converse the code output from the optimizer 23 into source binary code. Then, the back-end 24 may further send the annotation generator 25 with a block list containing attributes for related blocks in block 405. The back-end 24 may further send additional information to the annotation generator 25, such as block begin/end addresses.

In block 406, the annotation generator 25 of the compiler 102 may generate the annotation section in a pre-determined format based on the block lists and additional information collected in the block 404. An example of the pre-determined format is shown in FIG. 6.

In an embodiment that the annotation section may comprise an annotation table for a region with aforementioned structure, the annotation generator 25 may create a scope list for the region by analyzing every attribute for a block in the block lists and then defining boundary for each scope, and finally adding the block attributes to the scope list as attributes for the scope. Then, the annotation generator 25 may generate the annotation table by using the scope list and additional information, such as region begin/end address, scope begin/end address, region size, etc.

The following pseudo code give an example for establishing an annotation table:

Input: Internal representation of regions
Output: Annotation table that contains region-level metadata and scope-level metadata
Algorithm Annotation Generator

{

// 1^{st} step, collect information to form scopes for each region
For each region {

// Form scope list of current region, that is represented by scope boundary and attribute

information

Initialize scope list;
For each attribute ATTR{

For each basic block BB of current region {

Analyze current block;
If (the ATTR for current basic block can be described) {

If (there is no current scope) new a scope;
Add current block to current scope;

} Else {

If (there is current scope) {

End current scope;
Generate the attribute information that describes the attributes of

blocks inside current scope;

If (there is no scope in the scope list that has the same boundary in

the scope list) {

Add current scope into the scope list;
Add the attribute information into current scope;

} else {

Add the attribute information into the existent scope;

}

}

}

}

}

}
// 2^{nd} step, generate the region-level annotation and scope-level annotation
For each region {

Write the region boundary;
Write the information that helps build index to the region-level annotation, for example,

pointer to current region-level annotation, or the size of current region-level annotation;

For each scope {

Write the scope boundary;
For each attribute information {

Write the attribute type;
Write the content of the attribute information;

}

}

}

}

}

In block 407, the compiler 102 may output the source binary code with the annotation section.

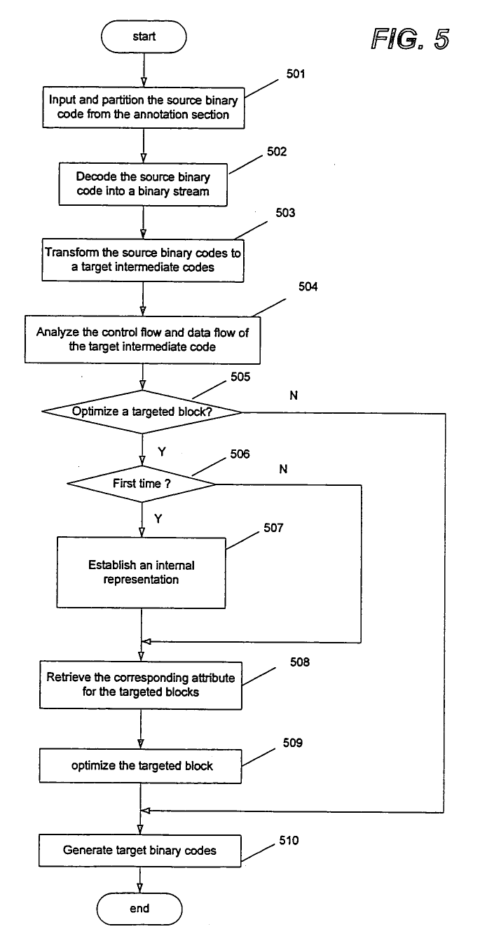

FIG. 5 shows an embodiment of a translating method to translate the source binary code to the target binary code. In block 501, the loader 31 of the translator 201 may input and partition the source binary code and the annotation section. In block 502, the decoder 32 of the translator 201 may decode the source binary code to the binary stream that the target intermediate code generator 33 may be designed to recognize and execute. In block 503, the target intermediate code generator 33 of the translator 201 may transform the source binary code to the target intermediate code. In block 504, the analyzer 34 of the translator 201 may analysis the control flow and data flow of the target intermediate code and map the source machine location to the target machine location.

In blocks 505-509, the optimizer 35 of the translator 201 may perform optimization with assistance from the annotation reader 36 if it is determined to be necessary. Although the optimization as shown in FIG. 5 is performed after the analysis, it should be appreciated that the optimization may be performed after other stage(s), such as the transformation stage in block 503. Alternatively, it may also be performed through the whole process of the translation, including optimization of the target binary code generation stage by the target binary code generator 37 (block 510). In such circumstances, the optimization blocks 505-509 may be implemented with integration with other stage(s), such as the transformation stage, target binary code generation stage, etc.

If an optimization is determined to be necessary in block 505, the annotation reader 36 of the translator 201 may determine whether it is the first time to read the annotation section in block 506. If the first time, the internal representation generator 361 will establish an internal representation for the annotation section (block 507). If not the first time, the retriever 362 of the annotation generator 36 may retrieve an attribute for a targeted block for optimization from the established internal representation in block 508.

In an embodiment, the internal representation may comprise a primary annotation internal representation for the annotation section and a secondary internal representation for each annotation table of the annotation section. The primary internal representation may be an AVL tree or a B+tree, with each node of the tree representing each annotation table. Each node of the AVL tree may comprise the begin address of the region of the annotation table, region size, and pointer to the annotation table. The secondary internal representation may be a AVL tree with each node of the tree representing each scope of the region of the annotation table. Each node of the AVL tree may comprise scope begin address, scope size, and attribute that each of the blocks of the scope has.

In other embodiments, blocks 506 and 507 may be omitted and the retriever 362 may retrieve the attribute directly from the annotation tables of the annotation section in block 508.

Then, in block 509, the optimizer 35 of the translator 201 may optimize the targeted block with assistance of the retrieved attribute. In block 510, the target binary code generator 37 of the translator 201 may convert the target intermediate code to the target binary code and rewrite them in the required format.

Although the present invention has been described in conjunction with certain embodiments, it shall be understood that modifications and variations may be resorted to without departing from the spirit and scope of the invention as those skilled in the art readily understand. Such modifications and variations are considered to be within the scope of the invention and the appended clams.

What is claimed is:

1. A compiling method, comprising compiling source code into source binary code for a first computing platform; and
generating an annotation section associated with the source binary code, the annotation section comprising an annotation for a scope, the scope comprising at least one block of the source binary code having at least one attribute to aid a translator optimization.

2. The compiling method of claim 1, wherein if the scope comprises a plurality of blocks, the blocks have consecutive addresses with each other and have the at least one attribute in common.

3. The compiling method of claim 1, wherein the annotation section further comprises a region annotation for a region comprising one or more scope.

4. The compiling method of claim 3, wherein the annotation for the scope further comprises scope addresses, scope size and the at least one attribute, and the annotation for the region further comprises a region annotation pointer, region addresses and region size.

5. The compiling method of claim 1, wherein the attribute comprises information associated with register spilling and restoring instructions within a block.

6. The compiling method of claim 1, wherein the attribute comprises information associated with local variable assignment within a block.

7. The compiling method of claim 1, wherein the attribute comprises information associated with volatile variable access within a block.

8. A translating method, comprising:
inputting source binary code for a first computing platform and an annotation section associated with the source binary code; and
translating the source binary code to a target binary code for a second computing platform by utilizing the annotation section,
wherein, an annotation section comprises an annotation for a scope, the scope comprising at least one block of the source binary code having at least one attribute to aid a translator optimization.

9. The translating method of claim 8, wherein if the scope comprises a plurality of blocks, the blocks have consecutive addresses with each other and have the at least one attribute in common.

10. The translating method of claim 8, wherein the annotation section further comprises an annotation for a region comprising one or more scope.

11. The translating method of claim 10, wherein the annotation for the scope further comprises scope addresses, scope size and the at least one attribute, and the annotation for the region further comprises a region annotation pointer, region addresses and region size.

12. The translating method of claim 8, wherein the attribute comprises information associated with register spilling and restoring instructions within a block.

13. The translating method of claim 8, wherein the attribute comprises information associated with local variable assignment within a block.

14. The translating method of claim 8, wherein the attribute comprises information associated with volatile variable access within a block.

15. The translating method of claim 8, wherein translating the source binary code for the source platform further comprises:
generating target intermediate code based upon the source binary code;
optimizing the target intermediate code by utilizing the annotation section; and
generating the target binary code for the target platform based upon the optimized target intermediate code.

16. The translating method of claim 15, wherein optimizing the target intermediate code further comprises:
generating an internal representation for the annotation section in response to determining that the internal representation has not been established;
reading from the annotation section an attribute associated with a block of the target intermediate code based upon the internal representation; and
optimizing the block based upon the read attribute.

17. The translating method of claim 16, wherein the internal representation is an AVL tree, a node of the AVL tree comprising region addresses and region annotation pointer.

18. A compiler, comprising:
a compiling component to compile source code into source binary code for a first computing platform;
an annotation generator to generate an annotation section associated with the source binary code, the annotation section comprising an annotation for a scope, the scope comprising at least one block of the source binary code having at least one attribute to aid a translator optimization.

19. The compiler of claim 18, wherein if the scope comprises a plurality of blocks, the blocks have consecutive addresses with each other and have the at least one attribute in common.

20. The compiler of claim 18, wherein the annotation section further comprises an annotation for a region comprising one or more scope.

21. The compiler of claim 20, wherein the annotation for the scope further comprises scope addresses, scope size and the at least one attribute, and the annotation for the region further comprises a region annotation pointer, region addresses and region size.

22. The compiler of claim 18, wherein the attribute comprises information associated with register spilling and restoring instructions within a block.

23. The compiler of claim 18, wherein the attribute comprises information associated with local variable assignment within a block.

24. The compiler of claim 18, wherein the attribute comprises information associated with volatile variable access within a block.

25. A translator, comprising:
an input component to input source binary code for a first computing platform and an annotation section associated with the source binary code; and
a translate component to translate the source binary code to target binary code for a second computing platform by utilizing the annotation section,
wherein, the annotation section comprises an annotation for a scope, the scope comprising at least one block of the source binary code having at least one attribute to aid a translator optimization.

26. The translator of claim 25, wherein if the scope comprises a plurality of blocks, the blocks have consecutive addresses with each other and have the at least one attribute in common.

27. The translator of claim 26, wherein the annotation section further comprises an annotation for a region comprising one or more scope.

28. The translator of claim 27, wherein the annotation for the scope further comprises scope addresses, scope size and the at least one attribute, and the annotation for the region further comprises a region annotation pointer, region addresses and region size.

29. The translator of claim 25, wherein the translate component generates target intermediate code based upon the source binary code; optimizes the target intermediate code by utilizing the annotation section; and generates the target binary code for the target platform based upon the optimized target intermediate code.

30. The translator of claim 25, wherein the translate component generates an internal representation for the annotation section in response to determining that the internal representation has not been established; read from the annotation section an attribute associated with a block of the target intermediate code based upon the internal representation; and optimizes the block based upon the read attribute.
